(19) United States
(12) Patent Application Publication
(10) Pub. No.: US 2004/0192570 A1
(43) Pub. Date: Sep. 30, 2004

(54) Soap impregnated fabric

(76) Inventor: Chandra Johnson, Rockford, IL (US)

Correspondence Address: Law Office of Marc D. Machtinger, Ltd., Mr. Marc D. Machtinger, Esq., Suite 350, 750 W. Lake Cook Road, Buffalo Grove, IL, 60089-2073, US

(21) Appl. No.: 10/809,231

(22) Filed: Mar. 25, 2004

Related U.S. Application Data
(60) Provisional application No. 60/457,194, filed on Mar. 25, 2003.

(51) Int. Cl. C11D 17/00

(52) U.S. Cl. 510/296

(57) ABSTRACT

A soap impregnated fabric and a method of making a soap impregnated fabric is disclosed. A normally solid soap is heated to a temperature above the soap's melting point, thus causing the soap to be in a liquid state. Scented oils and or coloring can be added to the soap while the soap is in a liquid state. Pieces of fabric are placed in the liquid soap and allowed to soak in the liquid soap until the fabric is sufficiently saturated with the liquid soap. The fabric pieces are removed from the liquid soap and the soap saturated into the fabric is allowed to solidify.

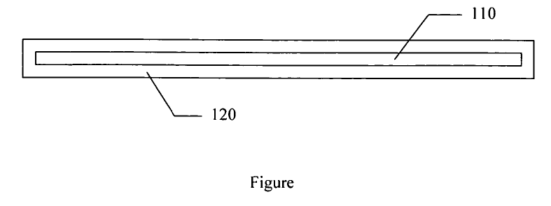

### CROSS-REFERENCE TO RELATED APPLICATIONS

This application claims the benefit of U.S. Provisional Patent Application No. 60/457,194, filed Mar. 25, 2003, which is hereby incorporated by reference in its entirety.

### BACKGROUND OF THE INVENTION

1. Field of the Invention

The present invention relates to soap impregnated fabric. More specifically, the present invention relates to a washcloth impregnated with soap.

2. Description of the Related Art

The advantages of using a piece of fabric with a soapy lather for bodily washing and scrubbing have been known for many years. Several attempts have been made to combine soap with a section of fabric. For example, U.S. Pat. No. 6,206,569, issued to Johnson, discloses a washcloth with a pocket positioned on one surface of the washcloth. The pocket is designed to hold a bar of soap therein.

U.S Pat. No. 6,098,234, issued to Jackson, Jr., discloses a glove assembly, a wash cloth assembly, and a buffer assembly. The glove assembly includes a soap receiving compartment for holding a piece of soap.

U.S. Pat. No. 6,085,380, issued to Gonda, et al., discloses a washing system using an implement including looped filaments, together with a surfactant-based cleanser. The loop filament implement is used in conjunction with a surfactant-based cleanser to generate a lather and cleanse the skin of a user. The user must put the cleanser on the implement for use.

U.S. Pat. No. 5,462,378, issued to Webb, discloses a washcloth adapted for retaining a bar of soap for use in the shower or bath. The washcloth is stitched together to form an internal pocket in a manner similar to that of a conventional sock. In use, a bar of soap is placed in the internal pocket. The washcloth contracts to conform the bar of soap as it is dispensed and used up, thereby reducing soap wastage.

U.S. Pat. No. 4,190,550, issued to Campbell, discloses a seamless, soap-filled pad. When the pad is used as a bathing aid, the pad imparts a cleansing and mildly stimulating rubbing action to human skin.

U.S. Pat. No. 6,495,151, issued to McAfee, et al., discloses a disposable cleansing article. The article is used by a consumer by wetting the dry article with water and then rubbing the article against the skin or hair. The article comprises a water soluble substrate having a cleansing surface that contains apertures of a certain size and frequency, and a lathering surfactant releasable associated with the substrate. The water soluble nature of the substrate causes the substrate to break down in water, which may aid in disposal of the article, but hinders reusing the article. Additionally, the article only has sufficient surfactant for a single use.

U.S. Pat. No. 4,948,585, issued to Schlein, discloses a disposable washcloth formed by impregnating a sheet to non-woven paper with a cured formulation of water activated polyurethane gel, a sudsing detergent, and an aqueous solution of a medicated cleansing agent. The paper substrate of the Schlein washcloth and the amount of cleanser hinders multiple uses of the washcloth.

U.S. Pat. No. 6063,397, issued to Fowler, et al., discloses a substantially dry, disposable personal cleansing product. The product comprises a water insoluble substrate, a lathering surfactant, and a conditioner component. As with the previously mentioned inventions, the Fowler invention is disposable and not intended for multiple uses.

The related art has many deficiencies. First, as disclosed in the Johnson, Jackson, and Webb patents, mentioned above, where the devices hold a bar or piece of soap, the soap is separate from the glove, mit, or washcloth, and the soap is not distributed throughout the soap containing device. In the Gonda patent, the soap or cleanser is completely separate from the cleansing device; the soap and the cleansing device merely being used in conjunction with one another as has been practiced for many years. In Campbell, the soap is interior to the cleansing pad, which requires wetting and manipulating the cleansing pad before a sufficient amount of soap reaches the surface of the cleansing pad for the pad to be used to cleanse the user's body. McAfee, Schlein, and Fowler all disclose disposable cleaning devices. Each of these devices lack a substrate suitable for repeated uses, and they lack sufficient soap disposed within the cleansing devices for the devices to be used for multiple cleansings.

There remains a need for multiple use soap impregnated washcloth. Thus, it would be advantageous to provide a washcloth or similar fabric impregnated with sufficient amounts of soap for multiple uses.

### SUMMARY

In view of the deficiencies described above, it is an object of the present invention to provide a soap impregnated fabric. It is a further object of the present invention to provide a reusable soap impregnated washcloth.

The present invention includes a soap impregnated fabric and a method of making a soap impregnated fabric. According to the present invention, a normally solid soap is heated to a temperature above the soap's melting point, thus causing the soap to be in a liquid state. Optionally, scented oils and or coloring can be added to the soap while the soap is in a liquid state.

Pieces of fabric, having been cut to a desired size and shape, are placed in the liquid soap. The pieces of fabric are allowed to soak in the liquid soap until the fabric is sufficiently saturated with the liquid soap. The fabric pieces are removed from the liquid soap and the soap saturated into the fabric is allowed to solidify.

Other features and advantages of the invention will be apparent from the following detailed description taken in conjunction with the following figures, wherein like reference numerals represent like features.

### BRIEF DESCRIPTION OF THE DRAWING

The figure shows a side view of a soap impregnated fabric according to the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a soap impregnated fabric and a method of making a soap impregnated fabric.

To make a soap impregnated fabric according to the present invention, a normally solid soap is heated to a temperature above the soap's melting point, thus causing the soap to be in a liquid state. Preferably the soap is a glycerin based soap, suitable for bodily cleansing.

Optionally, scented oils and or coloring can be added to the soap while the soap is in a liquid state. Scented oils may be added to give the soap a pleasant aroma which can be beneficial both to attract a prospective purchaser and to impart the aroma from the oil to a user of the soap impregnated fabric. The scented oils may also provide a therapeutic effect to the use through the science of aromatherapy. Coloring may also be added to increase the attractiveness of the soap impregnated fabric.

Pieces of fabric, having been cut to a desired size and shape, are placed in the liquid soap. In various embodiments the pieces of fabric can be made from cotton cloth or any other suitable fabric. Preferably, the pieces of fabric are suitable for use as a washcloth. In some embodiments, the fabric pieces are rectangular in shape. The pieces of fabric are allowed to soak in the liquid soap until the fabric is sufficiently saturated with the liquid soap.

The fabric pieces are removed from the liquid soap and the soap saturated into the fabric is allowed to solidify. The solidification process can include cooling and/or drying of the liquid soap. Once the soap is solidified, the soap impregnated fabric is substantially rigid. In various embodiments, the soap impregnated fabric is solidified in a substantially flat manner, lying along substantially a single plane. Typically the soap impregnated fabric has a thickness between 3 mm and 5 mm. Overall thickness can depend on the thickness of the fabric prior to soaking in the soap and how much soap is saturated into the fabric.

The resultant product is a soap impregnated fabric. The figure shows a side view of a soap impregnated fabric according to the present invention. The fabric 110 is shown as having soap 120 impregnating and fully enveloping the fabric 110.

The soap impregnated fabric is suitable for use as a reusable washcloth. Typically, the soap impregnated fabric is suitable for between 2 and 5 uses. For each use, the soap impregnated fabric is wetted, which allows a user to create a lather from the soap impregnated into the fabric. The fabric, along with the soapy lather, is used to cleanse the skin of the user. After each use the fabric can be allowed to dry, during which time the fabric returns to being substantially rigid. When the soap impregnated into the fabric is consumed through repeated cleansing cycles, the fabric may be disposed, used as a conventional washcloth, or re-impregnated with soap using the process of the present invention.

While specific embodiments have been illustrated and described, numerous modifications come to mind without significantly departing from the spirit of the invention and the scope of protection is limited by the scope of the accompanying claims.

What is claimed is:

1. A method of making soap impregnated fabric comprising:
cutting a section of fabric to a desired shape and size,
heating a normally solid soap to a temperature above the melting temperature of said soap, wherein said soap substantially becomes a liquid,
soaking said section of fabric in said liquid until said section of fabric becomes substantially saturated with said soap,
removing said fabric from said soap, and
solidifying said soap saturated fabric.

2. The method of making soap impregnated fabric according to claim 1, wherein after said solidifying step, said soap impregnated fabric is substantially rigid.

3. The method of making soap impregnated fabric according to claim 1, wherein after said solidifying step, said soap impregnated fabric is substantially flat.

4. The method of making soap impregnated fabric according to claim 1, wherein said fabric is a washcloth.

5. The method of making soap impregnated fabric according to claim 1, wherein said fabric comprises cotton.

6. The method of making soap impregnated fabric according to claim 1, wherein cutting a section of fabric to a desired shape and size comprises cutting a section of fabric into a substantially rectangular shape.

7. The method of making soap impregnated fabric according to claim 1, wherein after said solidifying step, said soap impregnated fabric has a thickness between approximately 3 mm and approximately 5 mm.

8. The method of making soap impregnated fabric according to claim 1, further comprising adding scented oil to said liquid soap prior to said soaking step.

9. The method of making soap impregnated fabric according to claim 1, further comprising adding coloring to said liquid soap prior to said soaking step.

10. The method of making soap impregnated fabric according to claim 1, wherein said normally solid soap is glycerin based.

11. A soap impregnated fabric made from the process comprising the steps:
cutting a section of fabric to a desired shape and size,
heating a normally solid soap to a temperature above the melting temperature of said soap, wherein said soap becomes a liquid,
soaking said section of fabric in said liquid soap until said section of cloth becomes substantially saturated with said soap,
removing said fabric from said soap, and
solidifying said soap saturated fabric.

12. The soap impregnated fabric according to claim 10, wherein after said drying and cooling step, said soap impregnated fabric is substantially rigid.

13. The soap impregnated fabric according to claim 10, wherein after said drying and cooling step, said soap impregnated fabric is substantially flat.

14. The soap impregnated fabric according to claim 11, wherein said fabric is a washcloth.

15. The soap impregnated fabric according to claim 11, wherein said fabric comprises cotton.

16. The soap impregnated fabric according to claim 11, wherein cutting a section of fabric to a desired shape and size comprises cutting a section of fabric into a substantially rectangular shape.

17. The soap impregnated fabric according to claim 11, wherein after said solidifying step, said soap impregnated fabric has a thickness between approximately 3 mm and approximately 5 mm.

18. The soap impregnated fabric according to claim 11, wherein the process further comprise the step of adding scented oil to said liquid soap prior to said soaking step.

19. The soap impregnated fabric according to claim 11, wherein the process further comprising adding coloring to said liquid soap prior to said soaking step.

20. The soap impregnated fabric according to claim 11, wherein said normally solid soap is glycerin based.

21. A reusable soap impregnated washcloth comprising:
a section of fabric saturated by a normally solid soap while said normally solid soap is in a liquid state.

22. The reusable soap impregnated washcloth according to claim 21, wherein coloring has been added to said soap while in a liquid state.

23. The reusable soap impregnated washcloth according to claim 21, wherein scented oil has been added to said soap while in a liquid state.

24. The reusable soap impregnated washcloth according to claim 21, wherein said soap is glycerin based.

25. The reusable soap impregnated washcloth according to claim 21, wherein said washcloth is impregnated with sufficient soap for between approximately two and approximately five uses.
